(19) United States
(12) Patent Application Publication
(10) Pub. No.: US 2025/0129223 A1
(43) Pub. Date: Apr. 24, 2025

(54) PRE-IMPREGNATED NONWOVEN MATS HAVING IMPROVED FIRE PERFORMANCE

(71) Applicant: Owens Corning Intellectual Capital, LLC, Toledo, OH (US)

(72) Inventors: Jianhui Wu, Westerville, OH (US); Aaron Mann, Columbus, OH (US); Annabeth Ryder, Columbus, OH (US)

(21) Appl. No.: 18/835,753

(22) PCT Filed: Feb. 6, 2023
(86) PCT No.: PCT/US2023/062020

§ 371 Date: Aug. 5, 2024

Related U.S. Application Data
(60) Provisional application No. 63/307,324, filed on Feb. 7, 2022.

(51) Int. Cl. C08J 5/24; B32B 5/02; D04H 1/4218; D04H 1/72

(52) U.S. Cl. CPC C08J 5/244; B32B 5/022; D04H 1/4218; D04H 1/72; B32B 2260/021; B32B 2260/046; B32B 2262/101; B32B 2307/3065; B32B 2307/718; D10B 2505/02

(57) ABSTRACT

Pre-impregnated nonwoven mats having improved fire performance are provided. The pre-impregnated nonwoven mats contain a nonwoven base layer and an impregnation composition, wherein the impregnation composition comprises a thermoset resin material. The selection of both a particular basis weight and a particular caliper index for the nonwoven base layer enables an improved absorption and cure of the impregnation composition during the manufacturing process, which provides a desired fire performance for the pre-impregnated non-woven mat without the need for further fire-retardant coatings.

### CROSS-REFERENCE TO RELATED APPLICATION(S)

This application claims priority to and all benefit of U.S. Provisional Patent Application No. 63/307,324, filed on Feb. 7, 2022, the entire disclosure of which is fully incorporated herein by reference.

### FIELD

The present disclosure relates to pre-impregnated (“pre-preg”) fibrous mats having improved fire performance. More particularly, the present disclosure relates to fibrous mats comprising a nonwoven base layer and an impregnation composition, wherein the impregnation composition comprises a thermoset resin material. The nonwoven base layer is formed with a particularly selected basis weight and caliper index, which enables increased resin absorption and efficient cure of the impregnation composition during the manufacturing process. As such, the pre-impregnated nonwoven mats achieve a desired fire performance without the need for further fire-retardant coatings.

### BACKGROUND

Composite materials comprised of reinforcing fiber mats, such as glass fibers (known as, e.g., veils, webs, facers) are utilized in a variety of applications. Pre-impregnated mats, which are known in the art as “pre-pregs,” are fiber-reinforced mats impregnated with a thermosetting resin material. Upon impregnation, the resin is partially polymerized, which is known as “B-stage.” This pre-preg material is provided to end-product manufactures, who cure the pre-preg and utilize it as a reinforcement layer to core substates in the production of construction boards, such as wood fiber boards (e.g., oriented strand boards, “OSB”), office wall panels, gypsum boards, or polyisocyanurate foam boards, among other applications.

Fire resistance is of particular importance to manufacturers of construction products. Typically, in order to achieve the requisite fire performance of the noted end-products, manufactures are required to secondarily treat the pre-preg material with a flame-retardant coating, such as magnesium oxide. However, manufacturers have identified a need for a pre-preg product that is ready for direct commercial application to a core substrate (i.e., a product having the requisite fire performance without a secondary coating treatment).

As such, a need exists for a pre-impregnated fibrous mat, specifically a pre-impregnated nonwoven mat, that achieves the requisite fire performance without the addition of separate fire-retardant coatings, and without sacrificing the requisite mechanical performance expected of other pre-preg products (e.g., loss on ignition and tensile strength). SUMMARY

The general inventive concepts are directed to pre-impregnated nonwoven mats having improved fire performance. The pre-impregnated nonwoven mats include a nonwoven base layer comprising a plurality of randomly dispersed, individually chopped glass fibers, together with an impregnation composition comprising a thermoset resin material. It has been found that the selection of a particular basis weight and caliper index for the nonwoven base layer enables an efficient absorption and cure of the impregnation composition during the manufacturing process. In some embodiments of the present disclosure, the nonwoven base layer has a basis weight of at least 140 g/m² and a caliper index of 20 to 40. In other embodiments of the present disclosure, the nonwoven base layer has a basis weight of from 80to less than 130 g/m² and a caliper index of 40 to 100.

A method of forming a pre-impregnated nonwoven mat is also described. The method includes providing a cured nonwoven base layer formed from a plurality of randomly dispersed, individually chopped fibers, applying an impregnation composition comprising a thermoset resin material to the cured nonwoven base layer to form an impregnated nonwoven material, and partially curing the impregnated nonwoven material to form the pre-impregnated nonwoven mat, wherein the nonwoven base layer has a specific basis weight and caliper index selected to enable efficient absorption and cure of the impregnation composition. In some embodiments of the present disclosure, the nonwoven base layer has a basis weight of at least 130 g/m² and a caliper index of 20 to 40. In other embodiments of the present disclosure, the nonwoven base layer has a basis weight of from 80 to less than 130 g/m² and a caliper index of 40 to 100.

A composite material is also described. The composite material comprises a cured pre-impregnated nonwoven mat laminated to a core substrate, wherein the cured pre-impregnated nonwoven mat comprises a nonwoven base layer comprising a plurality of randomly dispersed, individually chopped glass fibers, and an impregnation composition comprising a thermoset resin material. In some embodiments of the present disclosure, the nonwoven base layer has a basis weight of at least 130 g/m² and a caliper index of 20 to 40. In other embodiments of the present disclosure, the nonwoven base layer has a basis weight of from 80 to less than 130 g/m² and a caliper index of 40 to 100.

### DESCRIPTION OF THE FIGURES

The advantages of the inventive concepts will be apparent upon consideration of the following detailed disclosure, especially when taken in conjunction with the accompanying drawings wherein:

FIG. 1 is an illustration of one possible application of an impregnation composition to a nonwoven base layer to form a pre-impregnated nonwoven mat;

FIG. 2 is a line plot showing the resin uptake of various reinforcing fiber mat base layers;

FIG. 3 is a line plot showing the substantially linear relationship between caliper index and resin uptake, in accordance with the inventive features set forth herein;

FIG. 4 is chart showing the improved resin uptake of samples prepared according to the present disclosure; and

FIG. 5 is a photograph showing the comparative char lengths of various pre-preg specimens.

### DETAILED DESCRIPTION

Disclosed herein are pre-impregnated nonwoven mats having improved fire performance. While the present disclosure describes certain embodiments of the pre-impregnated nonwoven mats in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

The pre-impregnated nonwoven mats of the present disclosure can comprise, consist of, or consist essentially of the essential elements of the disclosure as described herein, as well as any additional or optional element described herein, or which is otherwise useful in the disclosed technologies.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The general inventive concepts relate to pre-impregnated nonwoven mats. More particularly, the inventive concepts relate to pre-impregnated nonwoven mats comprising a nonwoven base layer and an impregnation composition, wherein the impregnation composition comprises a thermoset resin material. In accordance with the present disclosure, the nonwoven base layer comprises a plurality of randomly dispersed, individually chopped fibers, and an optional binder composition that binds the fibers together. The nonwoven base layer has a particularly selected basis weight and caliper index, which enables increased absorption and efficient cure of the impregnation composition during the manufacturing process. As such, the inventive pre-impregnated nonwoven mats achieve a desired fire performance without the need for further fire-retardant coatings.

In accordance with the present disclosure, exemplary fibers for forming the nonwoven base layer include, but are not limited to, glass fibers, synthetic fibers (e.g., polyester fibers, polyethylene fibers, polypropylene fibers, polyethylene terephthalate fibers, polyamide fibers, aramid fibers, polyaramid fibers), mineral fibers, carbon fibers, ceramic fibers, natural fibers (e.g., cellulose fibers, cotton fibers, jute fibers, bamboo fibers, ramie fibers, bagasse fibers, hemp fibers, coir fibers, linen fibers, kenaf fibers, sisal fibers, flax fibers, henequen fibers), or a blend of two or more different types of fibers.

In accordance with the present disclosure, the fibers for forming the nonwoven base layer may comprise inorganic fibers. In embodiments of the present disclosure, the inorganic fibers may be selected from the group consisting of glass fibers, mineral fibers, mineral wool, glass wool, rock wool, or mixtures thereof. In some embodiments, the inorganic fibers are selected from the group consisting of glass or mineral wool fibers. The inorganic fibers may optionally be blended with polymer fibers.

In embodiments of the present disclosure, the fibers comprise, or consist of, glass fibers. The glass fibers can be made from any type of glass including, but are not limited to, A-type glass fibers, C-type glass fibers, E-type glass fibers, S-type glass fibers, ECR-type glass fibers (e.g., Advantex® glass fibers commercially available from Owens Corning of Toledo, Ohio), high performance glass fibers, wool glass fibers, or combinations thereof.

In accordance with the present disclosure, the glass fibers used to form the nonwoven base layer may have a variety of fiber diameters. In some embodiments, the glass fibers used to form the nonwoven base layer have an average fiber diameter of 3 microns to 32 microns. In some embodiments, the glass fibers used to form the nonwoven base layer have an average fiber diameter of 13 microns to 23 microns. In some embodiments, the glass fibers used to form the nonwoven base layer have an average fiber diameter of 16 microns to 23 microns. In some embodiments, the glass fibers used to form the nonwoven base layer have an average fiber diameter of 16 microns to 18 microns. In some embodiments, a blend of glass fibers having different fiber diameters, such as a blend of smaller diameter glass fibers (e.g., an average fiber diameter of 3 microns to 11 microns) and larger diameter glass fibers (e.g., an average fiber diameter of 13 microns to 25 microns), may be used to form the nonwoven base layer.

In accordance with the present disclosure, the glass fibers used to form the nonwoven base layer may have a variety of fiber lengths. In some embodiments, the glass fibers used to form the nonwoven base layer have an average fiber length of 6 mm to 50 mm. In some embodiments, the glass fibers used to form the nonwoven base layer have an average fiber length of 12.7 mm to 38.1 mm. In some embodiments, the glass fibers used to form the nonwoven base layer have an average fiber length of 19.05 mm to 25.4 mm. In some embodiments, the glass fibers used to form the nonwoven base layer have an average fiber length of 6.35 mm to 12 mm, including an average fiber length of 10 mm. In some embodiments, a blend of glass fibers having different fiber lengths, such as a blend of shorter glass fibers (e.g., an average fiber length of 6.35 mm to 12.7 mm) and longer glass fibers (e.g., an average fiber length of 19.05 mm to 31.75 mm), may be used to form the nonwoven base layer.

In accordance with the present disclosure, the nonwoven base layer is characterized by an assembly of dispersed, randomly oriented, individually chopped fibers. Other reinforcing fiber mat base layers are known in the art including, e.g., continuous filament mats (“CFM”) and chopped strand mats (“CSM”). Traditionally, CFM and CSM mats are characterized by multiple strands of reinforcing fibers forming a bundle of directionally oriented fibers. CFM mats in particular typically comprise a plurality of unidirectional, parallel fiber bundles forming the mat base layer. As such, the nonwoven base layers described herein are distinct from CFM and CSM mats due to the random orientation of the individual dispersed fibers.

In accordance with the present disclosure, the nonwoven base layer may be formed by a variety of processes, including wet-laid process and dry-laid processes. In embodiments of the present disclosure, the nonwoven base layer is formed by a wet-laid process, wherein wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. The slurry containing the fibers is deposited onto a moving screen, wherein a substantial portion of the water is removed to form a web of randomly oriented fibers. An optional binder composition may then be applied, and the resulting nonwoven mat is dried to remove any remaining water and to cure the binder composition. The resultant nonwoven base layer is a formed assembly of dispersed, individual chopped fibers interconnected by the binder composition.

In accordance with the present disclosure, the nonwoven base layer optionally may comprise a binder composition that binds the fibers of the nonwoven base layer together. Unless otherwise specified, the terms “binder” and “binder composition” are used interchangeably herein, and refer to a material that holds one or more components of a nonwoven article together. Those of ordinary skill in the art will understand that a binder composition is often an aqueous mixture or solution of dissolved ingredients that cures to interconnect and bond the fibers together at one or more points along the fiber. Any conventional binder composition used to form nonwoven mats may be used to form the nonwoven base layer of the present disclosure. In some embodiments, the binder composition comprises a thermoset material, a thermoplastic material, or a mixture of a thermoset material and a thermoplastic material. In some embodiments, the binder composition consists of a thermoset material. In some embodiments, the binder composition comprises an acrylic material, styrene-acrylic material, styrene butadiene, polyvinyl alcohol, vinyl versatate, or combinations thereof. In some embodiments, the binder composition comprises polyacrylic acid, including, but not limited to, a low molecular weight polyacrylic acid with a weight average molecular weight at or below 10,000 Daltons.

The binder composition may optionally include additional components such as, e.g., dyes, oils, fillers, colorants, aqueous dispersions, UV stabilizers, lubricants, wetting agents, surfactants, viscosity modifiers, or antistatic agents.

In accordance with the present disclosure, the amount of binder composition present in the nonwoven base layer may be determined by measuring loss on ignition (LOI). In some embodiments, the nonwoven base layer has an LOI of 5% to 50%. In some embodiments, the nonwoven base layer has an LOI of 10% to 40%. In some embodiments, the nonwoven base layer has an LOI of 10% to 30%. In some embodiments, the nonwoven base layer has an LOI of 10% to 20%.

In accordance with the present disclosure, the cured nonwoven base layer is impregnated or otherwise infused with an impregnation composition to form the pre-impregnated nonwoven mat. In embodiments of the present disclosure, the impregnation composition may comprise a thermoset resin material or a blend of thermoset resin materials. In embodiments of the present disclosure, the impregnation composition may consist of a thermoset resin material or a blend of thermoset resin materials. In embodiments of the present disclosure, the impregnation composition may be devoid of fillers, i.e., devoid of filler ingredients. In embodiments of the present disclosure, the impregnation composition may be devoid of added fire-retardant ingredients.

In accordance with the present disclosure, the thermoset resin material may be B-stageable, meaning it can be partially cured at an initial stage and then the curing may be completed at a later, downstream stage. The thermoset resin material may comprise any material capable of being partially cured in the B-stage, such as, for example, phenol formaldehyde, melamine formaldehyde, an intumescent composition, or mixtures thereof. As used herein, the term “intumescent composition” refers to a material that swells when heated, e.g., when exposed to the heat of a fire. In embodiments of the present disclosure, the intumescent composition comprises one or more of vinyl acetate, vinyl versatate, melamine, or mixtures thereof. An exemplary intumescent resin includes, e.g., VINNAPAS® EZ 3112 resin manufactured by Wacker Chemie AG (Munich, Germany). VINNAPAS® EZ 3112 resin is a protective colloid stabilized dispersion of a vinyl acetate, ethylene and vinyl ester terpolymer, and is free from alkyl phenol ethoxylate (APEO) containing compounds. Another exemplary intumescent resin includes, e.g., EMULTEX™ FR 728 resin manufactured by Synthomer (London, United Kingdom). EMULTEX™ FR 728 resin is a colloid stabilized vinyl acetate-vinyl versatate copolymer dispersion. Another exemplary intumescent resin includes, e.g., GP®677D60 resin manufactured by Georgia-Pacific Chemicals LLC (Atlanta, Georgia).

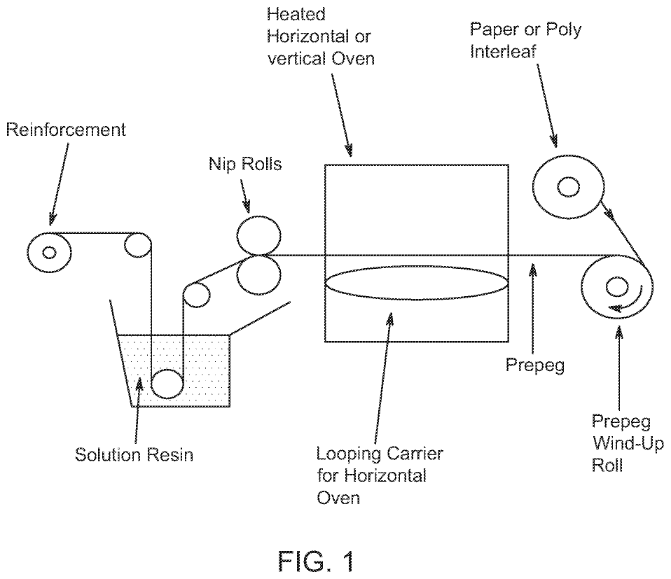

In accordance with the present disclosure, the impregnation composition may be applied to the nonwoven base layer via any known processes for forming pre-preg products. In some embodiments, the impregnation composition is applied to the nonwoven base layer via a dip coating technique, as illustrated in FIG. 1. In other embodiments, the impregnation composition may be applied to the nonwoven base layer via other dip coating methods, curtain coating, spray coating, kiss coating, roll coating, or any other known impregnation methods. In some embodiments, the impregnation composition extends partially into the thickness of the nonwoven base layer. In some embodiments, the impregnation composition extends fully through the thickness of the nonwoven base layer. The nonwoven base layer impregnated with the thermoset resin material constitutes the pre-impregnated nonwoven mat (i.e., the pre-preg).

In accordance with the present disclosure, the pre-impregnated nonwoven mats achieve the requisite fire resistance for a pre-preg product, without the need for a supplemental fire-retardant coating. Without being bound by theory, it is believed that the increased absorption of the thermoset resin into the nonwoven base layer (i.e., the “resin uptake” or the “resin consumption”) provides the requisite fire depression characteristics to the pre-impregnated nonwoven mats. In general, it has been found that nonwoven base layers achieve improved resin absorption and thus fire resistance in comparison to both CFM and CSM base layers. More specifically, it has been found that forming a nonwoven base layer with a particularly selected basis weight and caliper index enables increased resin absorption, which provides sufficient fire resistance of the pre-impregnated nonwoven mat without the application of additional fire-retardant ingredients or coatings. Subjectively, the caliper index generally indicates how structurally lofty a glass carrier mat is. Objectively, the caliper index is defined as thickness (mm) per unit area density or basis weight (BW). It has been surprisingly found that optimizing the basis weight and caliper index of the nonwoven base layer results in an optimization of the resin uptake, and thus an improved fire resistance of the pre-impregnated nonwoven mat. Without being bound by theory, it is further believed that in addition to the optimized resin consumption, a higher caliper index of the nonwoven base layer allows the pre-impregnated nonwoven mat freedom to expand in the z-direction, which improves the insulating effect during fire tests and thus the overall fire performance of the pre-impregnated nonwoven mat.

As such, in accordance with the present disclosure, the nonwoven base layer has both a basis weight and a caliper index particularly selected to enhance the resin uptake and thus the fire performance of the pre-impregnated nonwoven mat. Unless otherwise specified, the terms “basis weight” and “area density” are used interchangeably herein and are used to define a weight per unit area. In accordance with the art, the units g/m² for basis weight may be referred to in shorthand as “gsm.”

In some embodiments of the present disclosure, the nonwoven base layer has a basis weight of 130 g/m² or higher and a caliper index of 20 to 40. In some embodiments, the nonwoven base layer has a basis weight of 140 g/m² or higher and a caliper index of 20 to 40. In some embodiments, the nonwoven base layer has a basis weight of 150 g/m² or higher and a caliper index of 20 to 40. In some embodiments, the nonwoven base layer has a basis weight of 160 g/m² or higher and a caliper index of 20 to 40. In some embodiments, the nonwoven base layer has a basis weight of 170 g/m² or higher and a caliper index of 20 to 40. In some embodiments, the nonwoven base layer has a basis weight of 180 g/m² or higher and a caliper index of 20 to 40. In some embodiments, the nonwoven base layer has a basis weight of 190 g/m² or higher and a caliper index of 20 to 40. In some embodiments, the nonwoven base layer has a basis weight of 200 g/m² or higher and a caliper index of 20 to 40. In some embodiments, the nonwoven base layer has a basis weight of 130 g/m² to 300 g/m² and a caliper index of 20 to 40. In some embodiments, the nonwoven base layer has a basis weight of 140 g/m² to 300 g/m² and a caliper index of 20 to 40. In some embodiments, the nonwoven base layer has a basis weight of 150 g/m² to 300 g/m² and a caliper index of 20 to 40. In some embodiments, the nonwoven base layer has a basis weight of 160 g/m² to 300 g/m² and a caliper index of 20 to 40. In some embodiments, the nonwoven base layer has a basis weight of 170 g/m² to 300 g/m² and a caliper index of 20 to 40. In some embodiments, the nonwoven base layer has a basis weight of 180 g/m² to 300 g/m² and a caliper index of 20 to 40. In some embodiments, the nonwoven base layer has a basis weight of 190 g/m² to 300 g/m² and a caliper index of 20 to 40. In some embodiments, the nonwoven base layer has a basis weight of 200 g/m² to 300 g/m² and a caliper index of 20 to 40. In some embodiments, the nonwoven base layer has a basis weight of 150 g/m² to 250 g/m² and a caliper index of 20 to 40. In some embodiments, the nonwoven base layer has a basis weight of 200 g/m² to 225 g/m² and a caliper index of 20 to 40. In any of the foregoing embodiments, the nonwoven base layer may have a caliper index including from greater than 20 to less than 40, including from 20 to 35, including from 20 to 30, including from greater than 20 to less than 30, including from 21 to 29, including from 22 to 28, including from 23 to 27, including from 24 to 26, including a caliper index of 25.

In other embodiments of the present disclosure, the nonwoven base layer has a basis weight of from 80 g/m² to less than 130 g/m² and a caliper index of 40 to 100. In some embodiments, the nonwoven base layer has a basis weight of 80 g/m² to 120 g/m² and a caliper index of 40 to 100. In some embodiments, the nonwoven base layer has a basis weight of 85 g/m² to 115 g/m² and a caliper index of 40 to 100. In some embodiments, the nonwoven base layer has a basis weight of 85 g/m² to 100 g/m² and a caliper index of 40 to 100. In some embodiments, the nonwoven base layer has a basis weight of 85 g/m² to less than 100 g/m² and a caliper index of 40 to 100. In any of the foregoing embodiments, the nonwoven base layer may have a caliper index including from greater than 40 to less than 100, including from 40 to 70, including from 45 to 70, including from 50 to 70, including from 50 to 60, including from 55 to 65, including from 60 to 65.

In accordance with the present disclosure, the nonwoven base layer may have a variety of thicknesses provided the desired caliper index is achieved. In some embodiments, the nonwoven base layer has a thickness of 0.25 mm to 3 mm. In some embodiments, the nonwoven base layer has a thickness of 0.5 mm to 2.5 mm. In some embodiments, the nonwoven base layer has a thickness of 0.6 mm to 2 mm. In some embodiments, the nonwoven base layer has a thickness of 0.75 mm to 2 mm, including a thickness of 1 mm to 2 mm, a thickness of 1.25 mm to 1.9 mm, and a thickness of 1.5 mm to 1.8 mm.

In accordance with the present disclosure, the particularly selected basis weight and caliper index of the nonwoven base layer are associated with an improved resin uptake. Unless otherwise specified, the terms “resin uptake,” “resin consumption,” and “resin absorption” are all used interchangeably herein to describe the amount of thermoset resin absorbed into the nonwoven base layer.

In accordance with the present disclosure, the resin uptake (in grams) is measured by subtracting the weight of the nonwoven base layer (i.e., without resin impregnation) from the weight of the final pre-impregnated nonwoven mat. Said otherwise, the resin uptake is defined herein as the difference between the weight in grams of the pre-impregnated nonwoven mat and the weight in grams of the nonwoven base layer.

In accordance with the present disclosure, the resin uptake may also be expressed on a percentage basis, i.e., the resin uptake (in grams) divided by the weight (in grams) of the nonwoven base layer. Said otherwise, the resin uptake percentage is defined herein as [the weight (in grams) of the pre-impregnated nonwoven mat minus the weight (in grams) of the nonwoven base layer] divided by [the weight (in grams) of the nonwoven base layer]. In embodiments of the present disclosure, the resin uptake is at least 200%, including from 200% to 450%, including from 225% to 400%, including from 250% to 375%, and including from 275% to 350%.

In accordance with the present disclosure, it has been found that forming a nonwoven base layer with a particularly selected basis weight and caliper index enables increased resin absorption, and that an improved resin absorption correlates to an improved fire performance for pre-preg products. In some embodiments, char length is used to assess the fire performance, i.e., the flame resistance of a material. To measure char length, testing specimens are subjected to the fire of a Bunsen burner or other laboratory-scale controlled flame. One particular method for measuring char length is a flame retardancy test based upon UL94-5VA. The char length may be expressed analytically (i.e., inches of char length), or may likewise be assessed via visual inspection (i.e., the visual comparison of the char length of two different specimens subjected to the same controlled flame), with a shorter char length indicating a higher fire resistance.

In accordance with the present disclosure, the end-use of the pre-impregnated nonwoven mat is not limited, and may include the use of the pre-preg laminated or otherwise affixed to a core substrate including, but not limited to, construction boards, such as wood fiber boards (e.g., oriented strand boards (OSB) board), office wall panels, gypsum boards, polyisocyanurate foam boards, etc. In accordance with the present disclosure, a composite material may comprise the cured pre-impregnated nonwoven mat laminated to a core substrate. The following paragraphs provide further non-limiting exemplary embodiments.

Paragraph 1. A pre-impregnated nonwoven mat comprising: a nonwoven base layer comprising a plurality of randomly dispersed, individually chopped glass fibers; and an impregnation composition comprising a thermoset resin material, wherein the nonwoven base layer has a basis weight of at least 130 g/m² and a caliper index of 20 to 40, and wherein the nonwoven base layer achieves a resin uptake of at least 200%, based upon the weight of the nonwoven base layer.

Paragraph 2. The pre-impregnated nonwoven mat of paragraph 1, wherein the thermoset resin material comprises an intumescent resin.

Paragraph 3. The pre-impregnated nonwoven mat of any one of paragraphs 1 or 2, wherein the nonwoven base layer achieves a resin uptake of 200% to 450%, based upon the weight of the nonwoven base layer.

Paragraph 4. The pre-impregnated nonwoven mat of any one of paragraphs 1 to 3, wherein the nonwoven base layer achieves a resin uptake of 225% to 400%, based upon the weight of the nonwoven base layer.

Paragraph 5. The pre-impregnated nonwoven mat of any one of paragraphs 1 to 4, wherein the nonwoven base layer has a basis weight of from 130 to 300 g/m².

Paragraph 6. The pre-impregnated nonwoven mat of any one of paragraphs 1 to 5, wherein the nonwoven base layer has a basis weight of from 140 to less than 300 g/m².

Paragraph 7. The pre-impregnated nonwoven mat of any one of paragraphs 1 to 6, wherein the nonwoven base layer has a caliper index of 20 to 30.

Paragraph 8. The pre-impregnated nonwoven mat of any one of paragraphs 1 to 7, wherein the nonwoven base layer further comprises polymeric fibers.

Paragraph 9. The pre-impregnated nonwoven mat of any one of paragraphs 1 to 8, wherein the impregnation composition is devoid of filler ingredients.

Paragraph 10. The pre-impregnated nonwoven mat of any one of paragraphs 1 to 9, wherein the pre-impregnated nonwoven mat is devoid of added fire-retardant coatings.

Paragraph 11. A method of forming a pre-impregnated nonwoven mat, the method comprising: providing a cured nonwoven base layer formed from a plurality of randomly dispersed, individually chopped fibers; applying an impregnation composition comprising a thermoset resin material to the cured nonwoven base layer to form an impregnated nonwoven material; and partially curing the impregnated nonwoven material to form the pre-impregnated nonwoven mat, wherein the nonwoven base layer has a basis weight of at least 130 g/m² and a caliper index of 20 to 40, and wherein the nonwoven base layer achieves a resin uptake of at least 200%, based upon the weight of the nonwoven base layer.

Paragraph 12. The method of paragraph 11, wherein the nonwoven base layer achieves a resin uptake of 200% to 450%, based upon the weight of the nonwoven base layer.

Paragraph 13. The method of any one of paragraphs 11 or 12, wherein the nonwoven base layer achieves a resin uptake of 225% to 400%, based upon the weight of the nonwoven base layer.

Paragraph 14. The method of any one of paragraphs 11 to 13, wherein the nonwoven base layer has a basis weight of from 150 to 300 g/m².

Paragraph 15. The method of any one of paragraphs 11 to 14, wherein the thermoset resin material comprises an intumescent resin.

Paragraph 16. The method of any one of paragraphs 11 to 15, wherein the nonwoven base layer a caliper index of 20 to 30.

Paragraph 17. A composite material comprising a cured pre-impregnated nonwoven mat laminated to a core substrate, wherein the cured pre-impregnated nonwoven mat comprises: a nonwoven base layer comprising a plurality of randomly dispersed, individually chopped glass fibers; and an impregnation composition comprising a thermoset resin material, wherein the nonwoven base layer has a basis weight of at least 130 g/m² and a caliper index of 20 to 40, and wherein the nonwoven base layer achieves a resin uptake of at least 200%, based upon the weight of the nonwoven base layer.

Paragraph 18. The composite material of paragraph 17, wherein the core substrate comprises a wood fiber board, an office wall panel, a gypsum board, or a polyisocyanurate foam board.

Paragraph 19. The composite material of any one of paragraphs 17 or 18, wherein the core substrate comprises an oriented strand board.

Paragraph 20. A pre-impregnated nonwoven mat comprising: a nonwoven base layer comprising a plurality of randomly dispersed, individually chopped glass fibers; and an impregnation composition comprising a thermoset resin material, wherein the nonwoven base layer is selected from the group consisting of: a basis weight of at least 130 g/m² and a caliper index of 20 to 40; or a basis weight of from 80 to less than 130 g/m² and a caliper index of 40 to 100, wherein the nonwoven base layer achieves a resin uptake of at least 200%, based upon the weight of the nonwoven base layer.

Paragraph 21. A pre-impregnated nonwoven mat comprising: a nonwoven base layer comprising a plurality of randomly dispersed, individually chopped glass fibers; and an impregnation composition comprising a thermoset resin material, wherein the nonwoven base layer has a basis weight of from 80 to less than 130 g/m² and a caliper index of 40 to 100, and wherein the nonwoven base layer achieves a resin uptake of at least 200%, based upon the weight of the nonwoven base layer.

Paragraph 22. The pre-impregnated nonwoven mat of paragraph 21, wherein the thermoset resin material comprises an intumescent resin.

Paragraph 23. The pre-impregnated nonwoven mat of any one of paragraphs 21 or 22, wherein the nonwoven base layer achieves a resin uptake of 200% to 450%, based upon the weight of the nonwoven base layer.

Paragraph 24. The pre-impregnated nonwoven mat of any one of paragraphs 21 to 23, wherein the nonwoven base layer achieves a resin uptake of 225% to 400%, based upon the weight of the nonwoven base layer.

Paragraph 25. The pre-impregnated nonwoven mat of any one of paragraphs 21 to 24, wherein the nonwoven base layer has a basis weight of from 80 to 120 g/m².

Paragraph 26. The pre-impregnated nonwoven mat of any one of paragraphs 21 to 25, wherein the nonwoven base layer has a basis weight of from 85 to less than 100 g/m².

Paragraph 27. The pre-impregnated nonwoven mat of any one of paragraphs 21 to 26, wherein the nonwoven base layer has a caliper index of 50 to 70.

Paragraph 28. The pre-impregnated nonwoven mat of any one of paragraphs 21 to 27, wherein the nonwoven base layer further comprises polymeric fibers.

Paragraph 29. The pre-impregnated nonwoven mat of any one of paragraphs 21 to 28, wherein the impregnation composition is devoid of filler ingredients.

Paragraph 30. The pre-impregnated nonwoven mat of any one of paragraphs 21 to 29, wherein the pre-impregnated nonwoven mat is devoid of added fire-retardant coatings.

Paragraph 31. A method of forming a pre-impregnated nonwoven mat, the method comprising: providing a cured nonwoven base layer formed from a plurality of randomly dispersed, individually chopped fibers; applying an impregnation composition comprising a thermoset resin material to the cured nonwoven base layer to form an impregnated nonwoven material; and partially curing the impregnated nonwoven material to form the pre-impregnated nonwoven mat, wherein the nonwoven base layer has a basis weight of from 80 to less than 130 g/m² and a caliper index of 40 to 100, and wherein the nonwoven base layer achieves a resin uptake of at least 200%, based upon the weight of the nonwoven base layer.

Paragraph 32. The method of paragraph 31, wherein the nonwoven base layer achieves a resin uptake of 200% to 450%, based upon the weight of the nonwoven base layer.

Paragraph 33. The method of any one of paragraphs 31 or 32, wherein the nonwoven base layer achieves a resin uptake of 225% to 400%, based upon the weight of the nonwoven base layer.

Paragraph 34. The method of any one of paragraphs 31 to 33, wherein the nonwoven base layer has a basis weight of from 80 to 120 g/m².

Paragraph 35. The method of any one of paragraphs 31 to 34, wherein the thermoset resin material comprises an intumescent resin.

Paragraph 36. The method of any one of paragraphs 31 to 35, wherein the nonwoven base layer a caliper index of 50 to 70.

Paragraph 37. A composite material comprising a cured pre-impregnated nonwoven mat laminated to a core substrate, wherein the cured pre-impregnated nonwoven mat comprises: a nonwoven base layer comprising a plurality of randomly dispersed, individually chopped glass fibers; and an impregnation composition comprising a thermoset resin material, wherein the nonwoven base layer has a basis weight of from 80 to less than 130 g/m² and a caliper index of 40 to 100, and wherein the nonwoven base layer achieves a resin uptake of at least 200%, based upon the weight of the nonwoven base layer.

Paragraph 38. The composite material of paragraph 37, wherein the core substrate comprises a wood fiber board, an office wall panel, a gypsum board, or a polyisocyanurate foam board.

Paragraph 39. The composite material of any one of paragraphs 37 or 38, wherein the core substrate comprises an oriented strand board.

The general inventive concepts have been described above both generally and with regard to various specific exemplary embodiments. Although the general inventive concepts have been set forth in what are believed to be exemplary illustrative embodiments, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and do not limit the scope of the general inventive concepts described herein.

### Example 1

Six base layers were prepared in order to assess the resin uptake of various mat samples. Mat 1 (VL9202T—1 oz) was a nonwoven base layer having a basis weight of 300 gsm and a caliper index of 25, in accordance with the present disclosure. Mat 2 (VL9202—½ oz) was a nonwoven base layer having a basis weight of 150 gsm and a caliper index of 25, likewise in accordance with the present disclosure. Mat 3 (VL9202—⅜ oz) was a nonwoven base layer having a basis weight of 115 gsm and a caliper index of 26.5, i.e., a comparatively lower basis weight from the nonwoven Mats 1 and 2. Comparative mats 4 (CFM-M8686) and 5 (CFM-M8643) were continuous filament mats having a basis weight of 278 and a caliper index of 17.2, and comparative mat 6 (CSM-M723A) was a chopped strand mat having a basis weight of 332 gsm and a caliper index of 8.3. Each of the six base layers (cut to size 2″×10″) were assessed to measure their starting weight prior to resin impregnation (“initial weight”). The mats were then each individually impregnated with identical impregnation compositions comprising a 50/50 mixture of an intumescent resin and a melamine resin. Finally, each of the six impregnated samples were assessed to measure the weight of the pre-preg material (“final weight”).

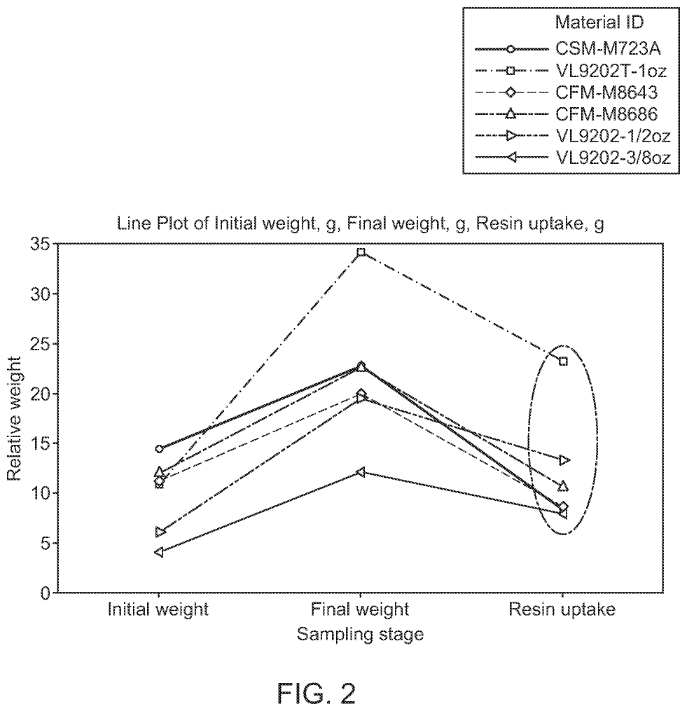

FIG. 2 is a line plot showing the resin uptake of the various samples. The resin uptake is measured in grams by subtracting the weight of the base layer (i.e., without resin impregnation) from the weight of the impregnated mats (i.e., the pre-preg material). As shown in FIG. 2, Sample 1, i.e., the nonwoven base layer having a basis weight of 300 gsm and a caliper index of 25 in accordance with the present invention exhibited a substantially higher resin uptake than the other samples. Further, Sample 2, i.e., the nonwoven base layer having a basis weight of 150 gsm and a caliper index of 25 in accordance with the present invention likewise exhibited an improved resin uptake as compared to Samples 3-6.

### Example 2

Fifteen base layers were prepared in order to compare the relationship between resin uptake and caliper index for chopped strand mats (“CSM”), continuous filament mats (“CFM”), and nonwoven base layers. Three samples were chopped strand mats having a basis weight of 330 gsm and caliper indexes ranging from 8 to 10. Six samples were continuous filament mats having basis weights ranging from 278 gsm to 326 gsm and caliper indexes ranging from 14 to 18. Three samples were nonwoven base layers in accordance with the present disclosure having a basis weight of 300 gsm and caliper indexes ranging from 25 to 30. Three samples were likewise nonwoven base layers in accordance with the present disclosure, having a basis weight of 90 gsm and caliper indexes ranging from 60 to 65. Each of the base layers (cut to size 2″×10″) were assessed to measure their starting weight prior to resin impregnation (“initial weight”). The mats were then each individually impregnated with identical impregnation compositions comprising a 50/50 mixture of an intumescent resin and a melamine resin. Finally, each of the impregnated samples were assessed to measure the weight of the pre-preg material (“final weight”). In accordance with the present disclosure, the resin uptake percentage was measured by subtracting the initial weight from the final weight, and dividing that value by the initial weight.

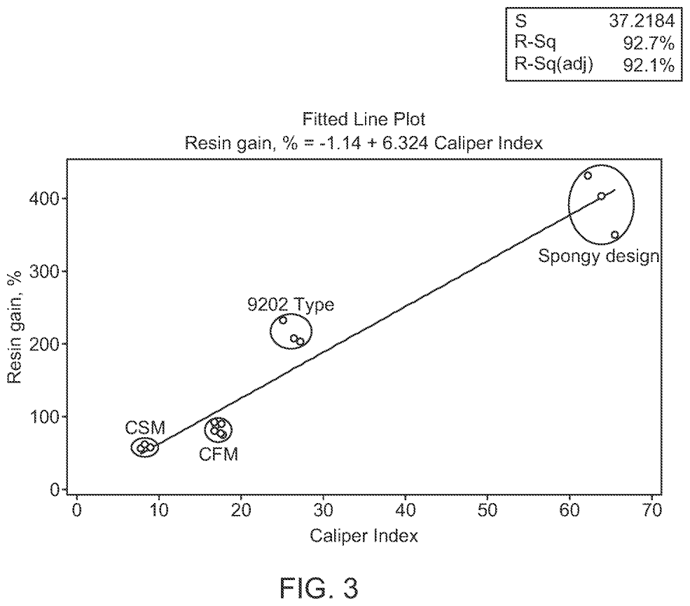

FIG. 3 is a line plot showing the substantially linear relationship between caliper index and resin uptake, in accordance with the inventive features set forth herein. Specifically, it has been found that a higher caliper index is associated with a higher resin uptake.

### Example 3

Four base layers were prepared in order to compare the resin uptake and ultimate fire performance of pre-preg products formed from chopped strand mats (“CSM”), continuous filament mats (“CFM”), and the nonwoven base layers in accordance with the present invention. Sample 1 (CSM-M723A) was a chopped strand mat having a basis weight of 332 gsm, a thickness of 0.57 mm, and a caliper index of 8.3. Sample 2 (CFM-M8686) was a continuous filament mat having a basis weight of 278 gsm, a thickness of 0.98 mm, and a caliper index of 17.2. Sample 3 (VL9202) was a nonwoven base layer in accordance with the present invention having a basis weight of 150 gsm, a thickness of 0.84 mm, and a caliper index of 25.8. Sample 4 (“EXP”) was a nonwoven base layer in accordance with the present invention having a basis weight of 225 gsm, a thickness of 1.22 mm, and a caliper index of 26.3. Each of the four base layers (cut to size 2″×10″) were assessed to measure their starting weight prior to resin impregnation (“initial weight”). The mats were then each individually impregnated with identical impregnation compositions comprising a 50/50 mixture of an intumescent resin and a melamine resin. Finally, each of the four impregnated samples were assessed to measure the weight of the pre-preg material (“final weight”). In accordance with the present disclosure, the resin uptake (in grams) was measured by subtracting the initial weight from the final weight.

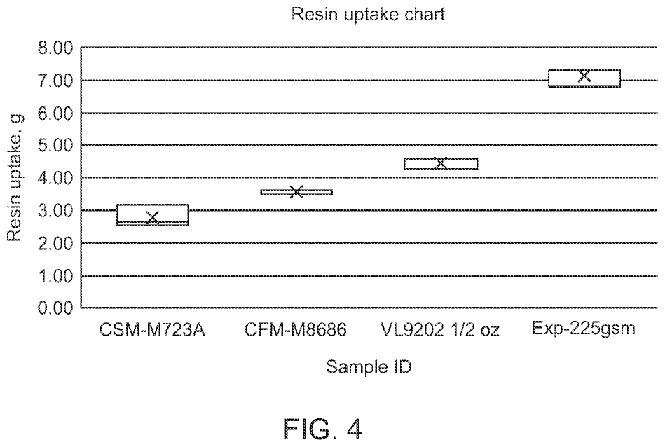

FIG. 4 shows that the resin uptake of the nonwoven samples prepared according to the present disclosure exhibited substantially improved resin uptake as compared to the CSM and the CFM samples. In particular, nonwoven Sample 4 having a particularly selected basis weight of 225 gsm and caliper index of 26.3 exhibited a resin uptake of 7.13 grams, as compared to the 2.78 gram and 3.56 gram resin uptakes of Samples 1 (CSM) and 2 (CFM), respectively.

Each of Samples 1-4 were thereafter assessed to compare the fire performance of each pre-preg. The fire performance of each sample was assessed using a modified version of UL94-5VA, e.g, using char length as an indicator of flame resistance. To measure char length, the bottom edge of each sample was subjected to a Bunsen burner having an overall flame height of about 110 mm and an inner blue flame height of 30 mm for a total of 10 seconds. The comparative char length of each of Samples 1-4 was assessed visually.

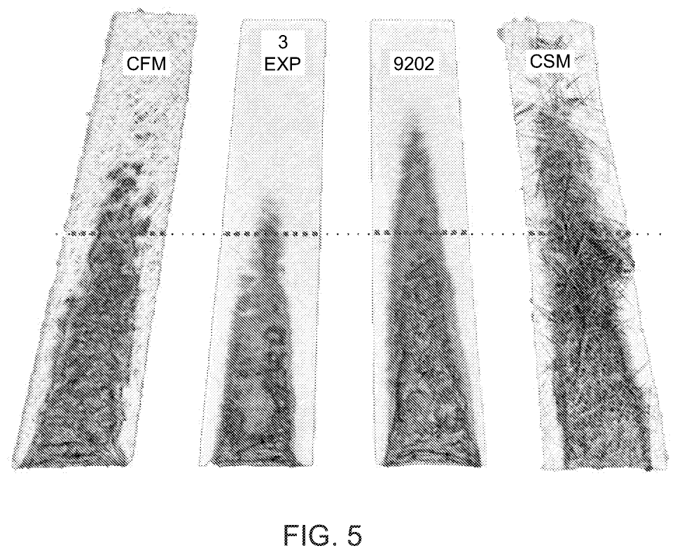

FIG. 5 shows the comparative char lengths of each of Samples 1-4. Specifically, it can be seen that the char length of Sample 4 (i.e., the experimental sample having a particularly selected basis weight of 225 gsm and a caliper index of 26.3) is substantially shorter than the CSM and CFM samples. As noted, this shorter char length is indictive of improved fire performance. Moreover, when considered in combination with the resin uptake chart of FIG. 4, it has been found that increased resin uptake correlates to improved fire performance. In particular, it has been found that a nonwoven base layer with a particularly selected basis weight and caliper index enables increased resin absorption as compared to other base layer materials (i.e., CFM and CSM base layers), which provides an improved fire resistance of the pre-impregnated nonwoven mat.

1. A pre-impregnated nonwoven mat comprising:
a nonwoven base layer comprising a plurality of randomly dispersed, individually chopped glass fibers; and
an impregnation composition comprising a thermoset resin material,
wherein the nonwoven base layer has a basis weight of at least 130 g/m² and a caliper index of 20 to 40, and wherein the nonwoven base layer achieves a resin uptake of at least 200%, based upon a total weight of the nonwoven base layer.

2. The pre-impregnated nonwoven mat of claim 1, wherein the thermoset resin material comprises an intumescent resin.

3. The pre-impregnated nonwoven mat of claim 1, wherein the nonwoven base layer achieves a resin uptake of 200% to 450%, based upon the total weight of the nonwoven base layer.

4. The pre-impregnated nonwoven mat of claim 1, wherein the nonwoven base layer achieves a resin uptake of 225% to 400%, based upon the total weight of the nonwoven base layer.

5. The pre-impregnated nonwoven mat of claim 1, wherein the nonwoven base layer has a basis weight of from 140 to 300 g/m².

6. The pre-impregnated nonwoven mat of claim 1, wherein the nonwoven base layer has a basis weight of from 150 to less than 300 g/m².

7. The pre-impregnated nonwoven mat of claim 1, wherein the nonwoven base layer has a caliper index of 20 to 30.

8. (canceled)

9. The pre-impregnated nonwoven mat of claim 1, wherein the impregnation composition is devoid of filler ingredients.

10. The pre-impregnated nonwoven mat of claim 1, wherein the pre-impregnated nonwoven mat is devoid of added fire-retardant coatings.

11-16. (canceled)

17. A composite material comprising a cured pre-impregnated nonwoven mat laminated to a core substrate, wherein the cured pre-impregnated nonwoven mat comprises the pre-impregnated nonwoven mat of claim 1.

18-20. (Canceled)

21. A pre-impregnated nonwoven mat comprising:
a nonwoven base layer comprising a plurality of randomly dispersed, individually chopped glass fibers; and
an impregnation composition comprising a thermoset resin material, wherein the nonwoven base layer has a basis weight of from 80 to less than 130 g/m² and a caliper index of 40 to 100, and wherein the nonwoven base layer achieves a resin uptake of at least 200%, based upon a total weight of the nonwoven base layer.

22. The pre-impregnated nonwoven mat of claim 21, wherein the thermoset resin material comprises an intumescent resin.

23. The pre-impregnated nonwoven mat of claim 21, wherein the nonwoven base layer achieves a resin uptake of 200% to 450%, based upon the total weight of the nonwoven base layer.

24. The pre-impregnated nonwoven mat of claim 21, wherein the nonwoven base layer achieves a resin uptake of 225% to 400%, based upon the total weight of the nonwoven base layer.

25. The pre-impregnated nonwoven mat of claim 21, wherein the nonwoven base layer has a basis weight of from 80 to 120 g/m².

26. (canceled)

27. The pre-impregnated nonwoven mat of claim 21, wherein the nonwoven base layer has a caliper index of 50 to 70.

28. (canceled)

29. The pre-impregnated nonwoven mat of claim 21, wherein the impregnation composition is devoid of filler ingredients.

30. The pre-impregnated nonwoven mat of claim 21, wherein the pre-impregnated nonwoven mat is devoid of added fire-retardant coatings.

31-36. (canceled)

37. A composite material comprising a cured pre-impregnated nonwoven mat laminated to a core substrate, wherein the cured pre-impregnated nonwoven mat comprises the pre-impregnated nonwoven mat of claim 21.

38-39. (canceled).

40. A B-staged, pre-impregnated nonwoven mat comprising:
a nonwoven base layer comprising a plurality of randomly dispersed, individually chopped glass fibers; and
a partially-cured impregnation composition comprising a thermoset resin material, wherein the wherein the nonwoven base layer is selected from the group consisting of:
a basis weight of at least 130 g/m² and a caliper index of 20 to 40; or
a basis weight of from 80 to less than 130 g/m² and a caliper index of 40 to 100, and wherein the nonwoven base layer achieves a resin uptake of at least 200%, based upon a total weight of the nonwoven base layer.
